(19) United States
(12) Patent Application Publication
(10) Pub. No.: US 2005/0218553 A1
(43) Pub. Date: Oct. 6, 2005

(54) Apparatus for and method of producing a pre-stretched plastic strap for securing packages, packaging containers or other articles

(76) Inventor: Daniel C. Mullock, Collegeville, PA (US)

Correspondence Address: Robert H. Frantz, P.O. Box 23324, Oklahoma City, OK, 73123, US

(21) Appl. No.: 10/818,479

(22) Filed: Apr. 5, 2004

(51) Int. Cl. B29C 55/02

(52) U.S. Cl. 264/175; 425/335; 425/363

(57) ABSTRACT

A pre-stretched plastic strap is produced for subsequent use in a strapping machine. Two mated pairs of rollers are attached to a drive mechanism causing each roller pair to roll at a predetermined rate. Each roller pair comprises a nip therebetween, one serving as a brake nip and one the other serving as a tensioner nip. The rolling speed of the tensioner nip is controlled higher than the rolling speed of the brake nip. A plastic strap is conducted through the brake nip and tensioner nip, and the rolling speed differential between brake and tensioner nips causes elongation of the strap conducted therethrough, with the strap having a predetermined tendency to return to its original, unstretched length. This abstract is submitted in compliance with USPTO rules, and is not intended to limit or otherwise indicate the scope of the claims.

### BACKGROUND OF THE INVENTION

1. Field of The Invention

This invention relates to a method for securing packages, packaging containers and other articles.

2. Description of the Related Art

The commercial use of strapping or banding has existed for decades. Strapping is typically used to bind items into bundles and/or to bind an item(s) onto pallets. A strapping dispenser is normally use to facilitate better speed and efficiency. These dispensers vary in size depending on the application and industry. Strapping is normally measured in width, thickness, break strength, pounds per coil, and coils per pallet. Initially strapping and strapping materials were most commonly made from leather or simple textile materials. Today, the strapping types most commonly used are steel, or polymer-based thermoplastics such as or polypropylene (PP), polyethylene terephthalate (PET), other polyesters or elastomers.

Strapping is frequently used in the packaging industry to prevent articles from uncontrolled shifting during transport, falling off a pallet, altering a prearranged packaging or pallet configuration or loosening from a packaging container. Productivity now dictates that the speed at which articles are packaged, palletized, and/or shipped is of great importance and the packaging section of a manufacturing process should not become a productivity bottleneck. Further, competitive economics require better utilization of warehouse space, so uniformity and performance demands placed on palletized and/or unitized articles continue to increase as pallets and/or units are stacked higher and in closer proximity than ever before.

Most manufacturing plants that produce individual articles utilize processes to unitize or palletize a plurality of articles, then wrap loaded pallets or units to prevent individual items from escaping and to preserve the finished dimensions of a palletized or unitized load. A typical strapping technique involves strapping material fed from a supply spool being wrapped around the palletized or unitized articles most commonly, sometimes by means of a rotary turntable in combination with a fixed supply spool, or using a carriage which supports a supply spool that travels around the palletized or unitized load while dispensing the strap.

Another commonly used system utilizes a fixed perimetric guide frame which provides for a unit or pallet to be positioned inside the frame, a strap is conducted through the frame and about the unit to be palletized, released from the frame, tightened, then crimped or otherwise fastened in place.

In nearly all strapping systems, strapping material is fed around the unit to form a loop, pulled to the desired tension, then secured. Most strapping system equipment comprises a dispenser which dispenses the strap from a spool, a tensioner which tightens the strap once in place, a crimper which attaches and secures the strap to itself, and a cutter which cleanly cuts the strap.

FIGS. 5a-5c illustrate a typical strapping apparatus and application. In FIG. 5a, plastic strap 9 is shown supplied from a spool 100 and directed around a tensioner wheel 101. Strap 9 then proceeds to the drive mechanism 102 which is comprised primarily of two drive/tensioner wheels 103. After a following a serpentine route through drive/tensioner wheels 103, plastic strap 9 is directed through welding/cutting mechanism 104 then through perimetric frame 105 where it encircles articles to be strapped, then eventually re-enters welding/cutting mechanism 104.

For illustration, said articles may comprise a typical application for PET bottles (e.g. soda pop bottles, product containers, etc.), wherein bottles 107 are regularly stacked in repeating rows, separated by interleaving sheets 108, capped by a top sheet 109 and placed on a pallet 106.

FIG. 5b shows strap 9 released from the perimetric frame 105 and pulled tight around subject load by means of reversing the direction of drive/tensioner wheels 103. Finally, FIG. 5c shows a tightly strapped unit after welding/cutting mechanism 104 welded an overlapping section of strap 9 together, then cut the strap entering from the drive mechanism 102.

A problem common to many strapping applications is a shifting, settling or shrinking of the articles being held by the strapping some time after the palletization and strapping operations are complete. This change in the size or volume of the strapped articles causes the strap tension to decrease, thus reducing the effectiveness of the strap.

One method employed to compensate for this product shifting, settling or shrinkage is to initially over-tighten the strap. This method, howeber, is particularly problematic when the articles are fragile or otherwise crushable as this limits the initial amount of strap tension and results in loose and ineffective strapping after settling, shrinking or shifting has occurred.

Therefore, what is needed in the art is a strapping method and apparatus which will contract or otherwise draw in at a rate substantially commensurate with the shrinking or settling of articles held thereby. Further, what is needed in the art is an apparatus and lo method for producing a strap that will contract or otherwise draw in at a rate substantially commensurate with the shrinking or settling of held articles.

### SUMMARY OF THE INVENTION

The present invention produces pre-stretched strap material for securing arranged or packaged articles prior to handling or shipment. The present invention is also directed to a method of pre-stretching a strap for securing arranged or packaged articles for handling or shipping by stretching an elastically stretchable strapping material immediately prior to use, then wrapping the article or articles and securing the pre-stretched strap.

The subject invention finds particular application for strapping an article or plurality of articles that tend to shrink individually, pack, or settle over time such that the strapped aggregate parcel becomes smaller over time. The present invention finds even more particular application for strapping an article or plurality of articles that are susceptible to crushing when strapped or banded too tightly.

### BRIEF DESCRIPTION OF THE DRAWINGS

The following drawings, which considered in conjunction with the description contained herein, provide a disclosure of our invention including one or more illustrative embodiments and methods for use thereof:

FIG. 1 shows a front view of the elements of subject stretching apparatus that directly interact with a plastic strap.

FIG. 2 provides a front view of the elements comprising the drive mechanism for subject apparatus.

FIG. 3a is a detailed front view of a nip comprised of two mated drive wheels.

FIG. 3b is a detailed cutaway side view of a nip.

FIG. 4a is a side view of the subject apparatus absent belt elements.

FIG. 4b is a side view of the apparatus with belt elements in place.

FIG. 5a-5c provide front views of a typical prior art strapping apparatus.

### DETAILED DESCRIPTION OF THE INVENTION

The present invention provides a means for pre-stretching a strapping material which has a damped elastic recovery characteristic, such as polyester strapping, for bundling or packaging applications, or for otherwise securing articles wherein the strap is pre-stretched to a predetermined amount immediately before application to the articles to be packaged. The amount of pre-stretching is adjusted to correlate with the amount of shrinkage, settling or shifting of the articles held within the strap over an certain period of time, thereby allowing the strap to shrink in a manner which compensates for load changes without the need for initial over-tensioning, and avoiding eventual strap loosening.

The present invention comprises a method and an apparatus wherein a elastic-memory strap is conducted in series through a plurality of nips, each nip defined by a pair of opposed rollers and each pair of rollers defining a nip therebetween. Both rollers in a pair rotate at the same speed and in opposite direction. For preferred functionality, nips are grouped in sets of two with the second set of two nips set to rotate at a higher relative speed than the first set of two nips such that when a plastic strap is conducted through entire series of nips, the first pair of nips effectively brake the strap while the second pair of nips effectively stretch the strap.

The relative speed between the first set of two nips and the second set of two nips is adjustable, thus providing for an adjustable amount of imparted stretch. Upon exiting the first set of nips, the strap is directed around a plurality of idler wheels then directed through the second set of nips. Upon leaving the last set of nips, the stretched strap is immediately fed to a conventional strapping machine or other strapping apparatus wherein the strap is applied to wrap a group of packages or articles, further pulled to a desired tension, then secured in place. Immediately after exiting the second brake nip, the pre-stretched polyester strap begins a process of slow, damped elastic recovery wherein the strap returns to the original unstretched length over a prolonged period of time, thus maintaining a more effective tension as wrapped packages or articles shift, settle or otherwise effectively shrink

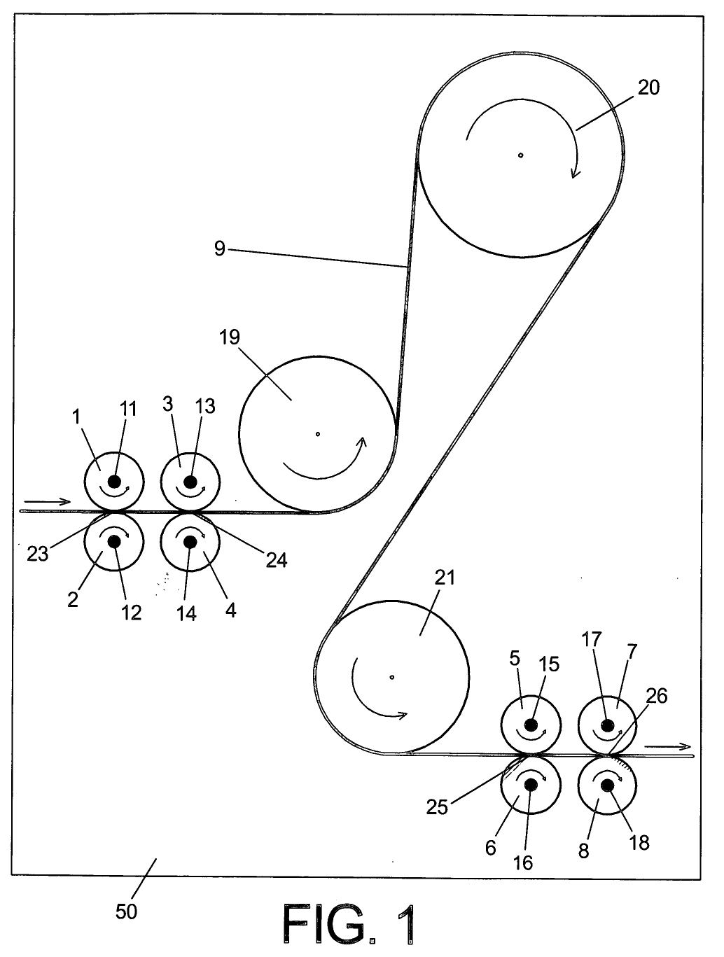

Referring to FIG. 1, the path of a plastic strap as it passes through our stretching unit is shown, according to our invention. Our apparatus utilizes and applies plastic strap which is known to have damped elastic recovery characteristics, at least in its lengthwise dimension, such that after being initially stretched, it will return to its original length (or a shorter, predicable length) over a period of time. Many ordinary strap materials, such as polyesters and polypropylene, have such characteristics, and can be used suitably well with our invention.

For clarification of FIG. 1, plastic strap 9 enters from the left and exits to the right of the drawing, a convention which is adopted for better illustration of the invention but in no way represents the only possible configuration of the invention.

Strap 9 passes through first brake nip 23 as defined by the pinch point between first drive wheel 1 and second drive wheel roller 2, then passes through second brake nip 24 as defined by the pinch point between third drive wheel 3 and fourth drive wheel 4. Drive wheels 1, 2, 3, and 4 are rotating as indicated in FIG. 1, and all four drive wheels are rotating at the same speed such that the linear speed through each nip is equal. Upon exiting second brake nip 24, strap 9 is preferably routed around a series of idler wheels, such as a first idler wheel 19, a second idler wheel 20 and a third idler wheel 21. In alternate embodiment of the invention, the idler wheels may comprise more or fewer wheels, be eliminated altogether, or be replaced in whole or part by other means of direction such as guides and slides.

Strap 9 is then directed through a second series of nips comprised of first tension nip 25 as defined by the pinch point between fifth drive wheel 5 and sixth drive wheel 6, and second tension nip 26 as defined by the pinch point between seventh drive wheel 7 and eighth drive wheel 8. Drive wheels 5, 6, 7 and 8 are rotating as indicated in is FIG. 1. Importantly, drive wheels 5, 6, 7 and 8 are rotating faster than drive wheels 1, 2, 3, and 4 so as to create a higher linear velocity through tension nips 25, 26 than through brake nips 23, 24.

This linear speed differential causes tensional forces in strap 9 as it passes through the series of nips such that first and second brake nips 23, 24 effectively brake the strap as first and second tension nips 25, 26 effectively stretch the strap so as to impart a measured amount of elastic deformation. As previously stated, drive wheels 1, 2, 3 and 4, have a common drive mechanism and rotate at the same speed. Likewise, drive wheels 5, 6, 7 and 8 also share a common drive mechanism and rotate at the same speed. However, the rotational speed of each set of drive wheels is adjustable so that the amount of stretch imparted to plastic strap 9 is adjustable.

In the preferred embodiment, strap 9 is pre-stretched between 4% and 8% as it exits second tension nip 26. Using a polyester strap, we have noted that about ⅓ of the pre-stretch (e.g. 2%-3%) will be recovered within a period of time such as a few hours or few days. Use of other materials with differing stretch recovery characteristics, or strapping of articles with more or less anticipated shrinkage, settling or shifting may require adjustment of our apparatus to produce more or less pre-stretching prior to strapping.

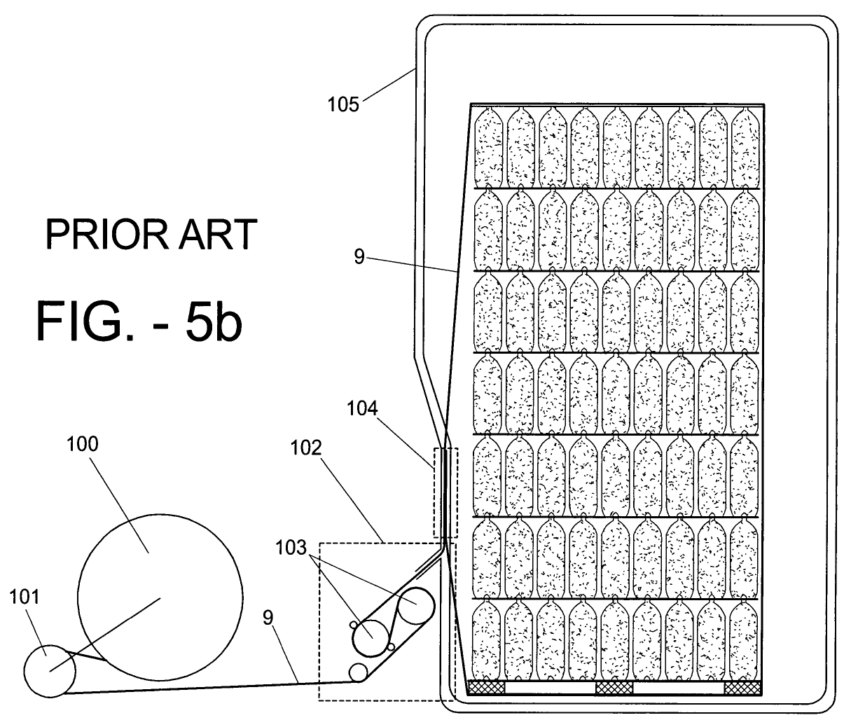

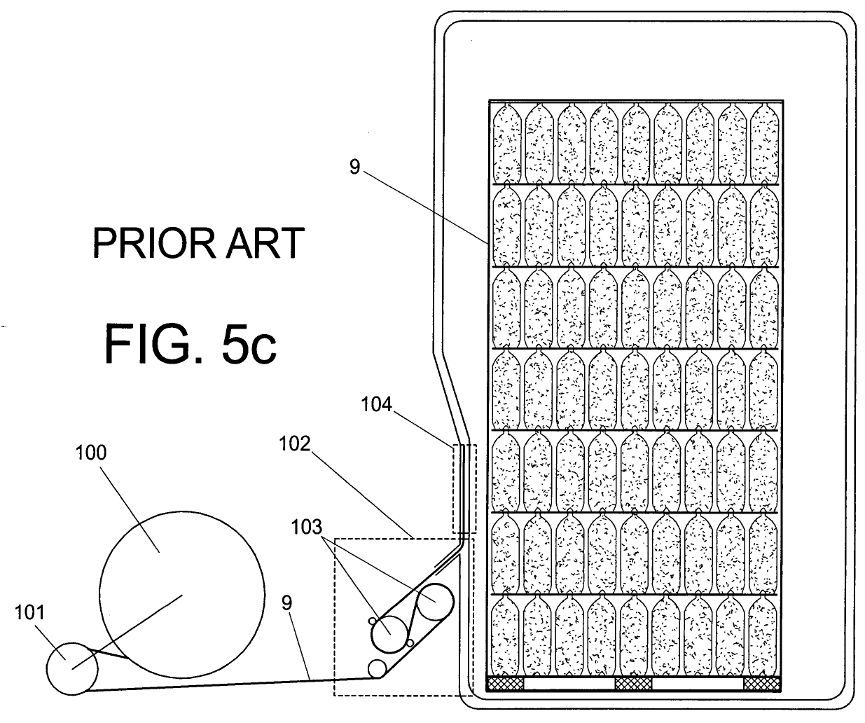

The nip pressure between each set of opposed drive wheels should be sufficiently high so as to prevent any slippage of strap 9 as it passes therethrough. During normal operation, strap 9 will be under tensile loading and will tend to slip forward as it passes through brake nips 23, 24 and backward as it passes through tension nips 25, 26. Upon exiting second tension nip 26, strap 9 is immediately fed to a conventional strapping machine such as disclosed FIGS. 5a-5c herein. In the preferred embodiment, the abutted outer surfaces of drive wheels 1-8 which come into contact with strap 9 are smooth, however, these surfaces can be textured such as with a knurled finish or otherwise roughened, or provided with small teeth, cogs, tines or other apparatus that provide for an effective grip between said drive wheels and strap 9.

Continuing with FIG. 1, the collective mechanism illustrated by FIG. 1 is mounted to the front side of base plate 50. Drive wheels 1, 2, 3, and 4 are rigidly and concentrically attached to first ends of shafts 11, 12, 13, and 14 respectively with each shaft penetrating through base plate 50. Likewise, drive wheels 5, 6, 7, and 8 are rigidly and concentrically attached to first ends of shafts 15, 16, 17, and 18 respectively with each shaft also penetrating through base plate 50. The connections between base plate 50 and shafts 11-18 where shafts 11-18 penetrate through said base plate 50 provides for free rotation of each shaft relative to base plate 50 and can be accomplished by a number of conventional means including concentrically mounting properly sized housings with bearings on one or both sides of penetration through base plate 50.

First, second and third idler wheels 19, 20, and 21 are each concentrically and rotatably attached to base plate 50 such that each idler wheel freely rotates about its center. Said attachment between idler wheels 19, 20, and 21 and base plate 50 can be by any of a number of conventional means such as a rigid axle attached to base plate 50 and fitted with necessary bearings, bushings and collars to provide freely rotatable attachment.

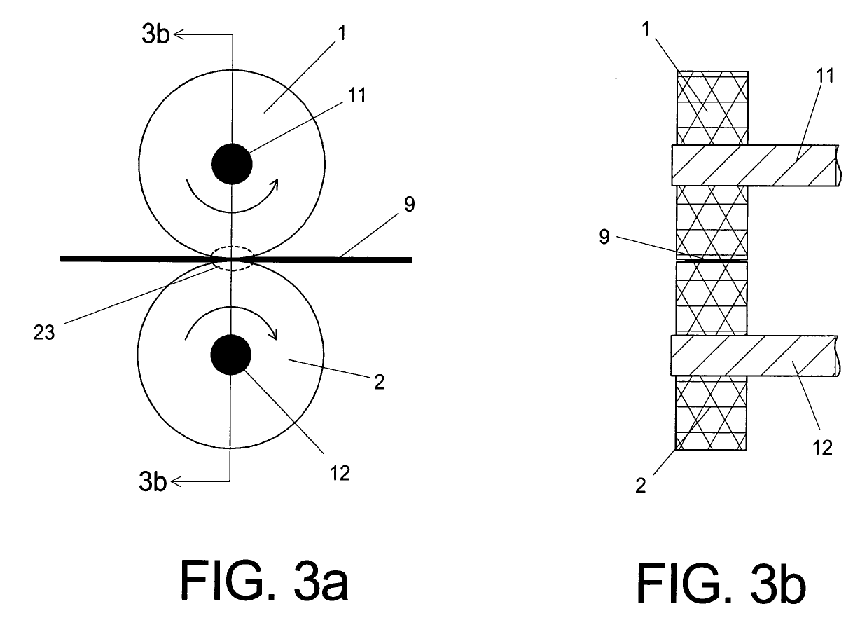

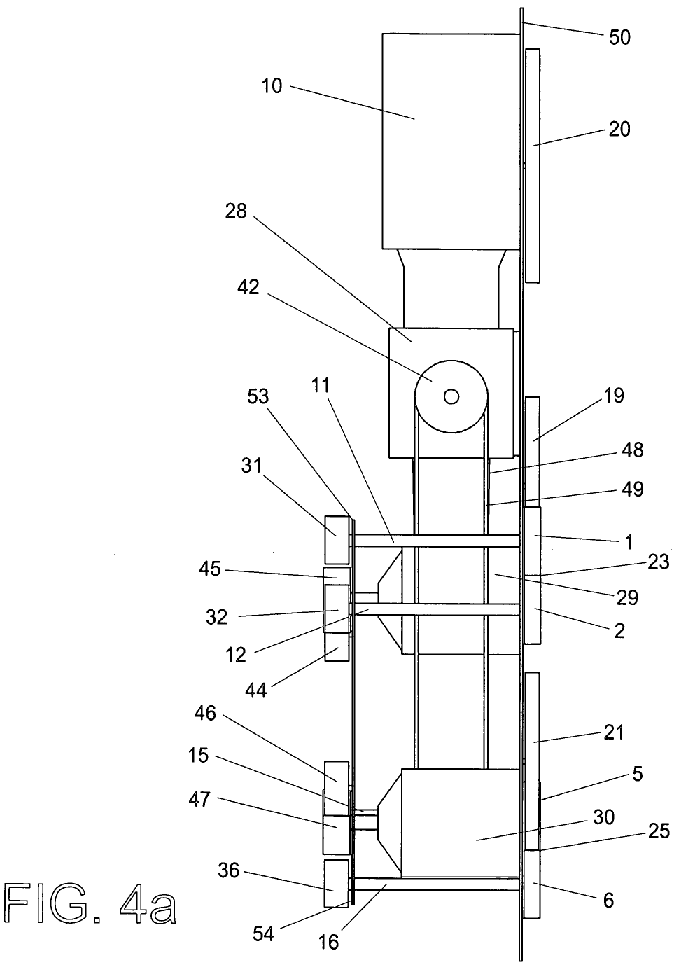

FIG. 3a provides a side view and FIG. 3b a cutaway end view of a typical nip and the components that comprise said nip, specifically, first brake nip 23. Referring first to FIG. 3a, first drive wheel 1 and second drive wheel 2 are shown with a portion of strap 9 located therebetween. The pinch point described as first brake nip 23 is also shown. In FIG. 3b, first and second shafts 11, 12 are shown with first and second drive wheels 1, 2 attached respectively thereon. As illustrated, in the preferred embodiment, drive wheels are sized to be wider than the plastic strap so as to insure adequate traction. As previously described, each drive wheel-shaft attachment should be sufficiently rigid so at to prohibit any relative movement therebetween. Also, the nip pressure between each set of opposed drive wheels must be sufficiently high so as to prevent any slippage of strap 9 as it passes therethrough.

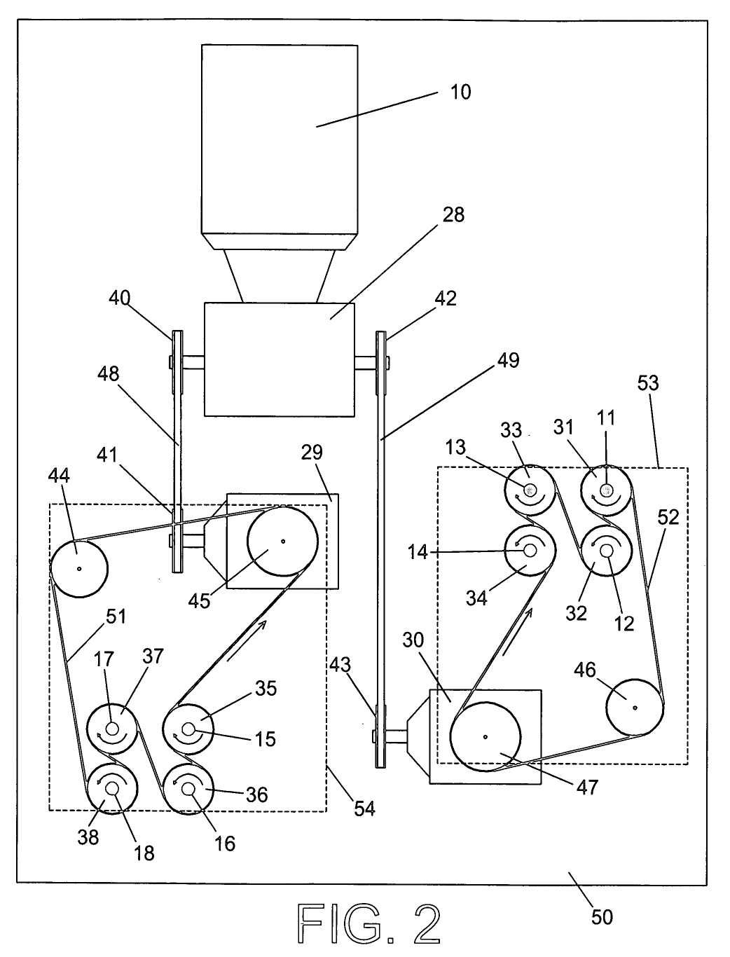

FIG. 2 provides a side view of the drive mechanism. For reference, the components shown in FIG. 2 are all located on the back side of base plate 50. Power for the entire mechanism comes from electric drive motor 10 which is mounted to base plate 50 and coupled to speed reducer 28. Said speed reducer 28 may be any suitable transmission mechanism equipped with one rotary input and two rotary shaft outputs. The horsepower rating of drive motor 10 and the gear ratio of speed reducer 28 can both be varied to attain a desirable operation.

In a preferred embodiment, electric drive motor 10 is rated at 3 HP and operates at 1750 RPM, and the gear ratio of speed reducer 28 provide a 5:1 shaft speed reduction. As illustrated, speed reducer 28 has an opposed dual shaft output that is fitted with first V-belt sheave 40 and second V-belt sheave 42. Two right angle gear boxes are utilized as illustrated by first gear box 29 and second gear box 30. Input shaft of first gear box 29 is fitted with an input V-belt sheave 41and coupled to speed reducer 28 by means of V-belt 48. Input shaft of second gear box 30 is fitted with an input V-belt sheave 43 and coupled to speed reducer 28 by means of V-belt 49. In the preferred embodiment, V-belts and belt sheaves are used to provide the coupling between speed reducer 28 and gear boxes 29, 30, but cogged V-belts or ribbed V-belts may be used. Further, sprocket and roller-chain couplings or other comparable drive couplings can be used.

The output shaft of first gear box 30 is fitted with output pulley 47 and associated idler pulley 46 is located adjacent thereto. First drive belt 52 is positioned about pulleys 46 and 47 and serpentined through crank wheels 31, 32, 33 and 34 as illustrated. Crank wheels 31, 32, 33 and 34 are rigidly and concentrically attached to the second ends of shafts 11, 12, 13 and 14 respectively. Further, the output shaft of second gear box 29 is fitted with output pulley 45 and associated idler pulley 44 is located adjacent thereto. Second drive belt 51 is positioned about pulleys 44 and 45 and serpentined through crank wheels 35, 36, 37 and 38 as illustrated. Crank wheels 35, 36, 37 and 38 are rigidly and concentrically attached to the second ends of shafts 15, 16, 17 and 18 respectively. As illustrated, crank wheels 35, 36, 37 and 38 are all the same size and share a common drive belt, thus rotate at the same speed.

Likewise, crank wheels 31, 32, 33 and 34 are identically sized, share a common drive belt, and rotate at the same speed. First gear box 30 and second gear box 29 are identical and in the preferred embodiment produce a 1:1 input to output drive ratio. A speed differential between the first group of crank wheels 31, 32, 33 and 34 and the second group of crank wheels 35, 36, 37 and 38 is preferably accomplished by varying the respective sizes of output V-belt sheaves 40 and 42, or by varying the respective sizes of input V-belt sheaves 41 and 43 such that the second group of crank wheels 35, 36, 37 and 38 rotate faster than the first group of crank wheels 31, 32, 33 and 34.

With continuing reference to FIG. 2, first mounting plate 53 and second mounting plate 54 are illustrated in FIG. 2 by dotted lines and represent mounting plates attached to and raised above base plate 50. First mounting plate 53 and second mounting plate 54 are in coplanar relative orientation, and both are attached to and raised above base plate 50 in parallel orientation therewith. Shafts 11, 12, 13 and 14 penetrate through and are rotatably attached to first mounting plate 53 by means of bearings and housings or comparable. Idler pulley 46 is rotatably attached to mounting plate 53 and output pulley 47 is positioned above mounting plate 53 while associated gear box 30 is positioned below.

Likewise, shafts 15, 16, 17 and 18 penetrate through and are rotatably attached to second mounting plate 54 by means of bearings and housings or comparable. Idler pulley 44 is rotatably attached to mounting plate 53 and output pulley 45 is positioned above mounting plate 53 while associated gear box 30 is positioned below. First and second mounting plates 53, 54 are used in the preferred embodiment, but can easily be replaced by properly positioned and secured brackets or other apparatus.

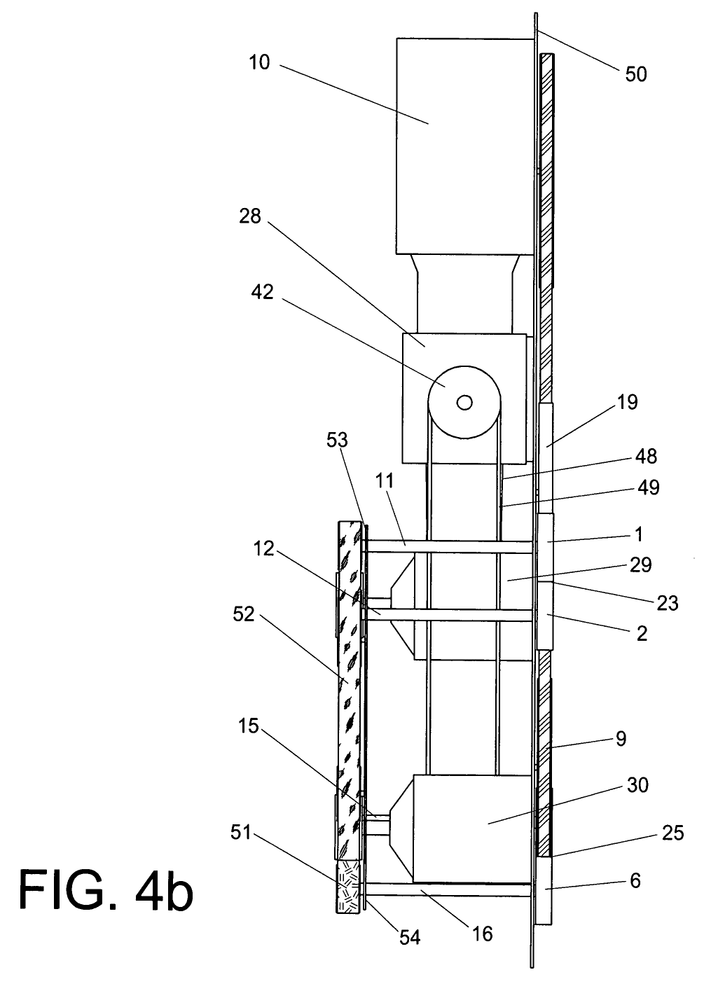

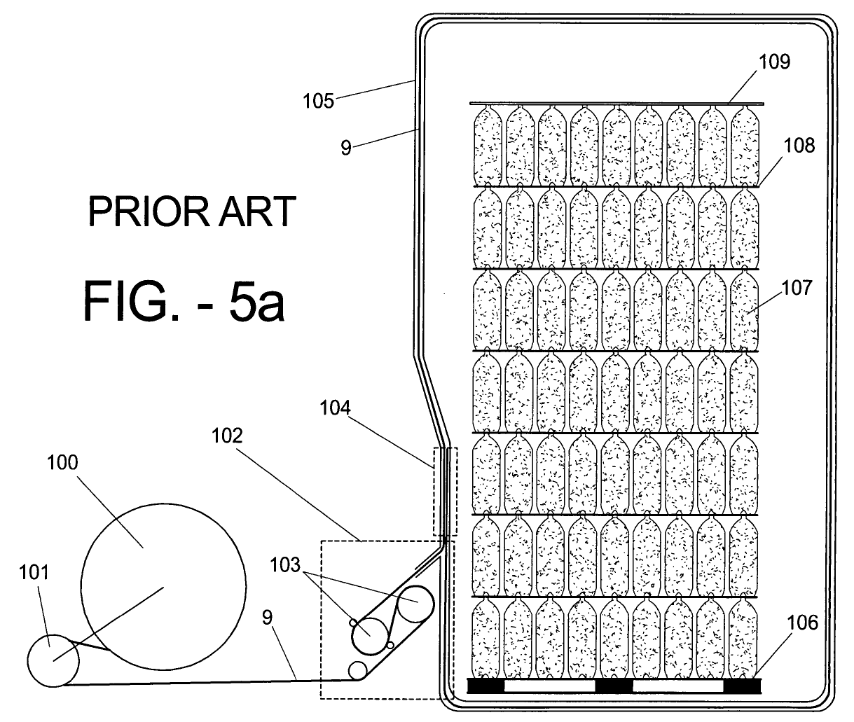

FIG. 4a and 4b provide end or elevation views of the subject apparatus. For reference, all components located left of base plate 50 are included in FIG. 2, while all components located right of base plate 50 are included in FIG. 1. Referring first to FIG. 4a, drive motor 10 is shown and is attached to speed reducer 28. Second output belt sheave 42 is shown, while first output belt sheave 40 is located on the opposite side of speed reducer 28 and is hidden from view. Second V-belt 49 is shown attached to second output belt sheave 42 and first V-belt 48 can be partially seen by virtue of first output belt sheave 40 being larger than second output belt sheave 42 in the preferred embodiment.

As previously disclosed, second V-belt 49 is attached to input belt sheave 43 (not shown) located on gear box 30, while first V-belt 48 is attached to input belt sheave 41 (not shown) located on gear box 29. In the preferred embodiment, drive motor 10, speed reducer 28, gear box 29, and gear box 30 are attached to base plate 50 by suitable attachment means such as welds, bolts or comparable. Continuing, first shaft 11 can be seen and is shown connected to first crank wheel 31 on the left, penetrating through base plate 50 and connected to first drive wheel 1 on the right. Second shaft 12 is then shown connected to second crank wheel 32 on the left, penetrating through base plate 50 and connected to second drive wheel 2 on the right. Fifth shaft 15 can partially be seen and is accordingly attached to crank wheel 35 on the left, penetrating through base plate 50, and connecting to drive wheel 5 on the right.

Finally, sixth shaft 16 is shown attached to sixth crank wheel 36 on the left, penetrating through base plate 50 and is shown connected to sixth drive wheel 6 on the right. As previously discussed, all shaft (11-18) penetrations through base plate 50 provide for free or otherwise unhindered rotation of each shaft, accomplished by means of a concentrically positioned bearing and housing, bushing or other suitable means. First mounting plate 53 and second mounting plate 54 are shown in the preferred position. Though not shown, attachment means between said mounting plate and base plate 50 may be suitably sized threaded rods, angled or flat members or other suitable apparatus preferably welded or bolted into position.

With continued reference to FIG. 4a, elements comprising the stretching mechanism that contact plastic strap 2, and those included in FIG. 2 are shown located to the right of base plate 50. Beginning at the top, second idler wheel 20, first idler wheel 19 and third idler wheel 21 are shown. As discussed supra, attachment between said idler wheels 19, 20 and 21 and base plate 50 must provide for free rotation of idler wheels and can be accomplished by a number of conventional means including a rigid axle welded or otherwise attached to base plate 50 provided with bearings, bushings or other low friction rotatable connection subsequently attached to subject idler wheels.

Continuing, first and second drive wheels 1, 2 are attached to first and second shafts 11, 12 respectively, and further comprise first brake nip 23. Below, fifth and sixth drive wheels 5, 6 are shown attached to fifth and sixth shafts 15, 16 respectively are further comprise first tension nip 25. For reference, first tension nip 25 lies in line with the lower surface of third idler wheel 21, thus is not readily apparent.

Referring finally to FIG. 4b, second drive belt 51 and first drive belt 52 are shown, as is plastic strap 9. Though not shown in FIG. 4b, plastic strap 9 enters the apparatus through first brake nip 23 and exits the apparatus through second tension nip 26 (not shown) located behind first tension nip 25.

The embodiments shown and described herein are exemplary. It is within the skill in the art to vary the details, arrangement, and materials utilized to realize a pre-stretching apparatus according to our invention. Therefore, the scope of the present invention should be determined by the following claims with reference to, but not necessarily limited to these illustrative embodiments.

1. A method of producing a pre-stretched strap for application to a load for packaging said load, said method comprising the steps of:
providing or receiving a portion of strap, said strap having a predicable damped elastic recovery characteristic;
directing said strap through at least one brake nip, said brake nip comprised of a pair of mated rollers each having an outer surface, said rollers rotating in opposite directions and at the same speed and spaced to provide a friction fit between rollers and said strap;
directing said strap through at least one tensioner nip, said tensioner nip comprised of a pair of mated rollers each having an outer surface, said rollers rotating in opposite directions and at the same speed, and being spaced to provide a friction fit between rollers and said strap;
pre-stretching said strap by rotating said tensioner nip rollers faster than said brake nip rollers such that said strap undergoes a pre-determined amount of lengthwise deformation as it passes between said brake nip and said tensioner nip, and;
providing said plastic strap to a strapping apparatus such that it is applied relatively immediately to one or more articles for packaging.

2. The method of claim 1 further comprising one or more idler wheels disposed between said brake nip and said tensioner nip such that they are each free to rotate at the same speed as said strap in contact therewith.

3. The method of claim 1 wherein said rollers each have a substantially cylindrical shape.

4. The method of claim 1 wherein the outer surfaces of said rollers comprising said brake nip are smooth.

5. The method of claim 1 wherein the outer surfaces of said rollers comprising said tensioner nip are smooth.

6. The method of claim 1 wherein the outer surfaces of at least one of said rollers comprising said brake nip is textured or otherwise roughened.

7. The method of claim 1 wherein the outer surfaces of at least one of said rollers comprising said tensioner nip is textured or otherwise roughened.

8. The method of claim 1 wherein said strap is comprised of a polyester.

9. The method of claim 1 wherein said strap is comprised of a thermoplastic polymer.

10. The method of claim 2 wherein said strap is directed through said idler wheels in a substantially serpentined manner.

11. The method of claim 1 wherein the outer surfaces of at least one of said rollers comprising said brake nip is provided with teeth, spurs, cogs, tines or the like.

12. The method of claim 1 wherein the outer surfaces of at least one of said rollers comprising said tensioner nip is provided with teeth, spurs, cogs, tines or the like.

13. An apparatus for pre-stretching a strap immediately before use in a packaging operation, said apparatus comprising:
a portion of strap, said strap having a predicable damped elastic recovery characteristic;
at least one brake nip comprised of a pair of mated rollers positioned to accept said strap through the nip therebetween, and said mated rollers being spaced to provide a friction fit between rollers and said strap;
at least one tensioner nip comprised of a pair of mated rollers positioned to accept said strap through the nip therebetween, and said mated rollers being spaced to provide a friction fit between the rollers and strap;
a differential drive means connected to said brake nip mated rollers and to said tension nip mated rollers, said drive means being capable of turning tensioner nip rollers at a faster rate than said brake nip rollers so as to impart a pre-determined amount of elastic deformation to said strap directed in series through said brake nip and said tensioner nip; and
a pre-stretched strap output means suitable for directing said elastically fdeformed strap to a strapping apparatus for substantially immediate application to one or more articles for packaging.

14. The apparatus of claim 13 wherein said drive means further comprises:
a motor;
a transmission having an input and a first and second output, said input coupled to said motor;
a first adjustable coupling means, said first adjustable coupling means attaching said first output of said transmission to said mated rollers comprising said brake nip; and
a second adjustable coupling means, said second adjustable coupling means attaching second output of said transmission to said mated rollers comprising said tensioner nip.

15. The apparatus of claim 14 wherein said first and second transmission outputs further comprise rotating shafts.

16. The apparatus of claim 15 wherein said first and second adjustable coupling means further comprise:
a first and second output belt sheave concentrically attached to said first and second transmission outputs respectively, said first belt sheave sized larger than said second belt sheave;
a first gear box having an input sheave and an output pulley;
a second gear box having an input sheave and an output pulley;
a first transmission belt positioned about said first output belt sheave and said input sheave of said first gear box;
a second transmission belt positioned about said second output belt sheave and said input sheave of said second gear box;
a first output belt connection means connected to output pulley of said first gear box and to said mated rollers of said tensioner nip; and
a second output belt connection means connected to-output pulley of said second gear box and to said mated rollers of said brake nip.

17. The apparatus of claim 16 wherein said first output belt connection means further comprises:
a first shaft having a first and second end with said first end concentrically connected to first roller of said mated rollers of said tensioner nip;
a second shaft having a first and second end with said first end concentrically connected to second roller of said mated rollers of said tensioner nip;
a first drive wheel having a substantially cylindrical shape and concentrically connected to second end of said first shaft;
a second drive wheel having a substantially cylindrical shape and concentrically connected to second end of said second shaft; and
a first drive belt positioned about said output pulley of said first gear box and said first and second drive wheels to as to provide translational motion therebetween.

18. The apparatus of claim 16 wherein said second output belt connection means further comprises:
a first shaft having a first and second end with said first end concentrically connected to first roller of said mated rollers of said brake nip;
a second shaft having a first and second end with said first end concentrically connected to second roller of said mated rollers of said brake nip;
a first drive wheel having a substantially cylindrical shape and concentrically connected to second end of said first shaft;
a second drive wheel having a substantially cylindrical shape and concentrically connected to second end of said second shaft; and
a second drive belt positioned about said output pulley of said second gear box and said first and second drive wheels to as to provide translational motion therebetween.

19. The apparatus of claim 13 wherein each roller comprising said brake nip has a substantially cylindrical shape with a substantially smooth outer surface.

20. The apparatus of claim 13 wherein each roller comprising said tensioner nip has a substantially cylindrical shape with a substantially smooth outer surface.

21. The apparatus of claim 13 wherein at least one of the rollers comprising said brake nip has a substantially textured or otherwise roughened outer surface.

22. The apparatus of claim 13 wherein at least one of the rollers comprising said tensioner nip has a substantially textured or otherwise roughened outer surface.

23. The apparatus of claim 13 wherein at least one of the rollers comprising said brake nip is provided with a plurality of teeth, cogs, tines or the like.

24. The apparatus of claim 13 wherein at least one of the rollers comprising said tensioner nip is provided with a pluality of teeth, cogs, tines or the like.
